(19) United States
(12) Patent Application Publication
(10) Pub. No.: US 2024/0332582 A1
(43) Pub. Date: Oct. 3, 2024

(54) ELECTRODE STRUCTURE FOR ELECTROCHEMICAL CELL, ELECTROCHEMICAL CELL, AND ELECTROCHEMICAL APPARATUS

(71) Applicant: HONDA MOTOR CO., LTD., Tokyo (JP)

(72) Inventors: Tetsushi Nishida, Wako-shi (JP); Yuta Shimada, Wako-shi (JP)

(21) Appl. No.: 18/589,460

(22) Filed: Feb. 28, 2024

(30) Foreign Application Priority Data
Mar. 29, 2023 (JP) 2023-053149

(51) Int. Cl. H01M 8/1065; H01M 4/94; H01M 8/0258; H01M 8/0271; H01M 8/1058; H01M 8/1069

(52) U.S. Cl. CPC H01M 8/1065; H01M 4/94; H01M 8/0258; H01M 8/0271; H01M 8/1069; H01M 8/1058

(57) ABSTRACT

An electrode structure includes a sheet-shaped electrode base member formed of a porous material. The electrode base member is provided with an electrode function part, and a seal function part. The electrode function part has a diffusion layer and a catalyst layer. The seal function part is disposed on at least an outer peripheral region of the electrode function part and formed by impregnating the electrode base member with an elastomer.

### CROSS-REFERENCE TO RELATED APPLICATION

Priority is claimed on Japanese Patent Application No. 2023-053149, filed Mar. 29, 2023, the content of which is incorporated herein by reference.

### BACKGROUND OF THE INVENTION

### Field of the Invention

The present invention relates to an electrode structure for an electrochemical cell, an electrochemical cell, and an electrochemical apparatus.

### Description of Related Art

As an electrochemical apparatus such as an electrolytic apparatus, a fuel cell, or the like, a configuration in which a stack obtained by stacking a plurality of electrochemical cells is used and electrolysis or power generation of a material is performed by each of the electrochemical cells in the stack is known (for example, see Japanese Unexamined Patent Application, First Publication No. 2022-141239).

The electrochemical apparatus disclosed in Japanese Unexamined Patent Application, First Publication No. 2022-141239 is a carbon dioxide electrolytic apparatus, and an electrochemical cell having the following configuration is used.

The electrochemical cell includes an anode electrode and a cathode electrode, an electrolyte film disposed between these electrodes, and a separator placed to overlap the opposite side to a side where an electrolyte film of each electrode is present. Both electrodes and the electrolyte film are integrated, and a peripheral region is held by a holding frame in this state. An anode solution flow passage is formed between one separator and the anode electrode, and a CO₂ gas flow passage is formed between the other separator and the cathode electrode. In addition, the anode electrode and the cathode electrode are connected to a power supply. An anode solution containing water flows through the anode solution flow passage, and carbon dioxide gas flows through the CO₂ gas flow passage.

In the electrochemical cell, when a voltage of the power supply is applied to the anode electrode and the cathode electrode, water in the anode solution is oxidized on the anode electrode to generate oxygen gas and hydrogen ions. The hydrogen ions generated at this time pass through the electrolyte film and advances toward the cathode electrode. Carbon monoxide is generated on the cathode electrode by a reduction reaction of carbon dioxide in the CO₂ gas flow passage, and reacts with the hydrogen ions passing through the electrolyte film to generate water. The carbon monoxide generated on the cathode electrode passes through an external discharge passage and is taken out.

Further, in such an electrochemical cell, an elastomer seal part configured to seal a space between the holding frame configured to hold the electrode and the peripheral region of the electrolyte film and the separator adjacent thereto is provided therebetween. This prevents leakage of the solution and the gas from the solution flow passage and the gas flow passage in the electrochemical cell.

### SUMMARY OF THE INVENTION

In the above-mentioned electrochemical cell, the elastomer seal part is provided to prevent leakage of a fluid from a peripheral region of the flow passage to the outside. The elastomer seal part is formed to bulge toward a mated abutting member in order to control fluid leakage, is crushed when the mated abutting member is pressed against it, and exhibits a seal function in that state. In the above-mentioned electrochemical cell, since the seal part is formed to bulge in the stacking direction of the cells, a thickness of the electrochemical cell in the stacking direction tends to increase.

In addition, in the above-mentioned electrochemical cell, since the elastomer seal part is formed to bulge in the stacking direction of the cells, a total crush amount of each seal part is increased when the plurality of stacked electrochemical cells are fastened and fixed in the stacking direction. For this reason, when assembling the electrochemical apparatus, it is difficult to securely fasten the plurality of electrochemical cells.

An aspect of the present invention is directed to providing an electrode structure for an electrochemical cell, an electrochemical cell, and an electrochemical apparatus which are capable of reducing a thickness of the electrochemical cell in a stacking direction, and facilitating assembly of the electrochemical apparatus. Thus, the present invention, in turn, contributes to mitigating or reducing the impact of climate change.

An electrode structure for an electrochemical cell, an electrochemical cell, and an electrochemical apparatus according to the present invention employ the following configurations.

That is, an electrode structure for an electrochemical cell of an aspect of the present invention includes a sheet-shaped electrode base member (for example, an electrode base member 20 of an embodiment) formed of a porous material, the electrode base member being provided with an electrode function part (for example, an electrode function part 21 of the embodiment) having a diffusion layer and a catalyst layer, and a seal function part (for example, a seal function part 22 of the embodiment) disposed on at least an outer peripheral region of the electrode function part and formed by impregnating the electrode base member with an elastomer.

In the electrochemical cell of the aspect, the electrode base member formed of the porous material is provided with the electrode function part, and the seal function part configured to surround at least the outer peripheral region of the electrode function part. Then, the seal function part is configured by impregnating the porous material of the electrode base member with the elastomer. For this reason, the elastomer of the seal function part is supported by the porous material of the electrode base member. Accordingly, since the seal function part does not easily collapse even when pressed against other members in the stacking direction, there is no need to make the seal part bulge greatly in the stacking direction in advance. Accordingly, when the electrochemical cell of the aspect is employed, the electrochemical cell can be thinned in the stacking direction, and the plurality of electrochemical cells can be easily fastened and fixed upon assembly of the electrochemical apparatus.

The seal function part may be placed on the electrode base member, and abut a separator (for example, a first separator 13 and a second separator 14 of the embodiment) that forms a flow passage for an electrochemical reaction fluid between the separator and the electrode function part, or a holding frame (for example, a holding frame 30 of the embodiment) of the separator.

In this case, since the seal function part of the electrode structure abuts the separator adjacent thereto or the holding frame, leakage of the electrochemical reaction fluid to the outside from the flow passage between the separator and the electrode function part can be prevented by the seal function part of the electrode structure.

An electric conduction part (for example, an electric conduction part 40 of the embodiment), which is electrically conducted to the electrode function part and which is not impregnated with the elastomer, may be disposed on at least a part of an outer edge portion of the electrode base member.

In this case, the electrode function part of the electrode structure can be connected to an external electric circuit such as a power supply circuit or the like through the electric conduction part of the outer edge portion of the electrode structure without adding a complicated electric conduction structure.

An electrochemical cell of an aspect of the present invention includes a pair of sheet-shaped electrode structures (for example, electrode structures 11A and 11B of the embodiment); an electrolyte film (for example, an electrolyte film 12 of the embodiment) disposed between the pair of electrode structures and configured to allow penetration of ions; and a pair of separators (for example, a first separator 13 and a second separator 14 of the embodiment) respectively disposed on sides of each of the electrode structures which are opposite sides of sides where the electrolyte film is present in each of the electrode structures and configured to form a flow passage (for example, an anode-side flow passage 15 and a cathode-side flow passage 16 of the embodiment) for an electrochemical reaction fluid between the separators and the electrode structures, the pair of electrode structures including sheet-shaped electrode base members (for example, an electrode base member 20 of the embodiment) formed of a porous material, the electrode base member being provided with an electrode function part (for example, an electrode function part 21 of the embodiment) having a diffusion layer and a catalyst layer, and a seal function part (for example, a seal function part 22 of the embodiment) disposed on at least an outer peripheral region of the electrode function part and formed by impregnating the electrode base member with an elastomer, and the seal function part of each of the electrode structures abuts the separator, or a holding frame (for example, a holding frame 30 of the embodiment) of the separator.

An electrochemical apparatus of an aspect of the present invention includes the plurality of electrochemical cells; a pair of end plates (for example, end plates 2 of the embodiment) configured to sandwich the plurality of electrochemical cells from both sides in a stacking direction; and a fastening member (for example, a fastening member 3 of the embodiment) configured to fasten the pair of end plates and fix the plurality of electrochemical cells to each other in an approaching direction.

According to the aspect of the present invention, it is possible to reduce a thickness of the electrochemical cell in the stacking direction and facilitate assembly of the electrochemical apparatus. Then, by adopting the present invention, it is possible to contribute to mitigating or reducing the impact of climate change.

### BRIEF DESCRIPTION OF THE DRAWINGS

FIG. 1 is a perspective view of an electrochemical apparatus of an embodiment.

FIG. 2 is an exploded perspective view of an electrochemical cell of a first embodiment.

FIG. 3 is an exploded front view of a part of the electrochemical cell of the first embodiment.

FIG. 4 is a cross-sectional view corresponding to a cross section along line IV-IV of FIG. 2.

FIG. 5 is a cross-sectional view corresponding to a cross section along line V-V of FIG. 2.

FIG. 6 is an exploded front view of a part of an electrochemical cell of a second embodiment.

FIG. 7 is a cross-sectional view of the electrochemical cell of the second embodiment corresponding to FIG. 4 of the first embodiment.

FIG. 8 is a cross-sectional view of the electrochemical cell of the second embodiment corresponding to FIG. 5 of the first embodiment.

FIG. 9 is an exploded front view of a part of an electrochemical cell of a third embodiment.

### DETAILED DESCRIPTION OF THE INVENTION

Hereinafter, embodiments of the present invention will be described with reference to the accompanying drawings. In the embodiments described below, common parts are designated by the same reference signs, and overlapping description thereof will be partially omitted.

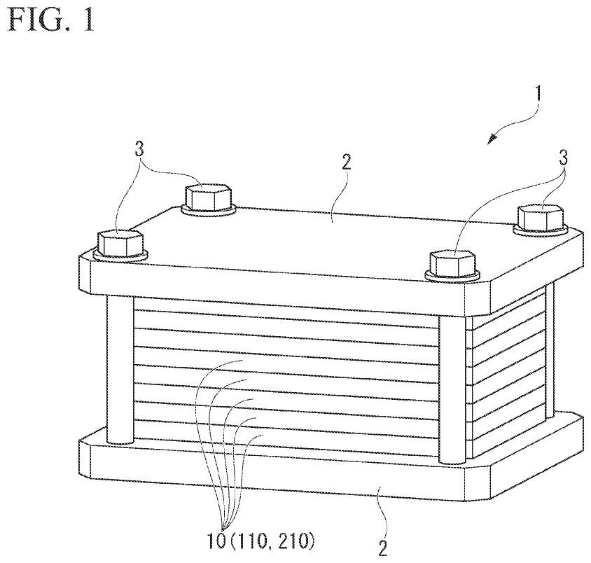

FIG. 1 is a perspective view of an electrochemical apparatus of an embodiment.

The electrochemical apparatus of the embodiment is an electrolytic apparatus 1 configured to electrolyze carbon dioxide into carbon compounds such as carbon monoxide or the like.

The electrolytic apparatus 1 includes a plurality of electrochemical cells 10 (110, 210) stacked in a thickness direction, a pair of end plates 2 that sandwich the plurality of electrochemical cells 10 (110, 210) in a stacking direction from both sides, and a fastening member 3 (for example, a bolt and a nut) configured to fasten the pair of end plates 2 in an approaching direction and fix the plurality of electrochemical cells 10 (110, 210) to each other.

### First Embodiment

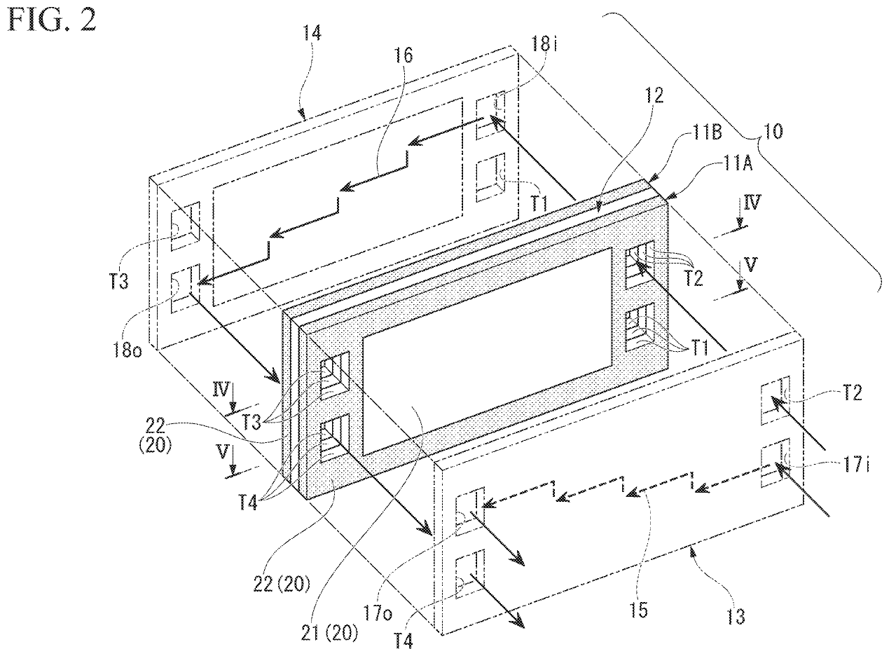

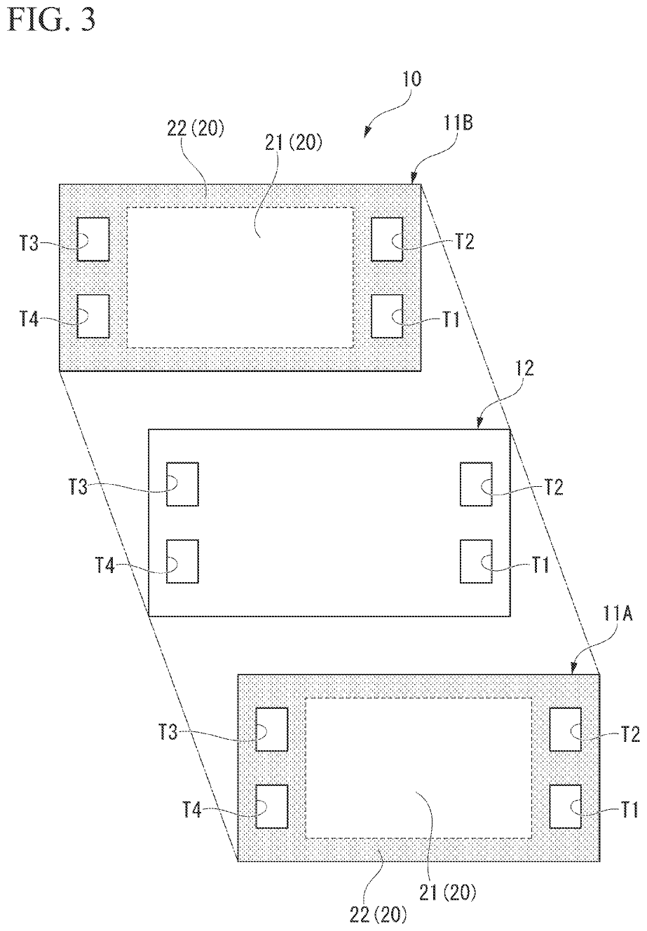

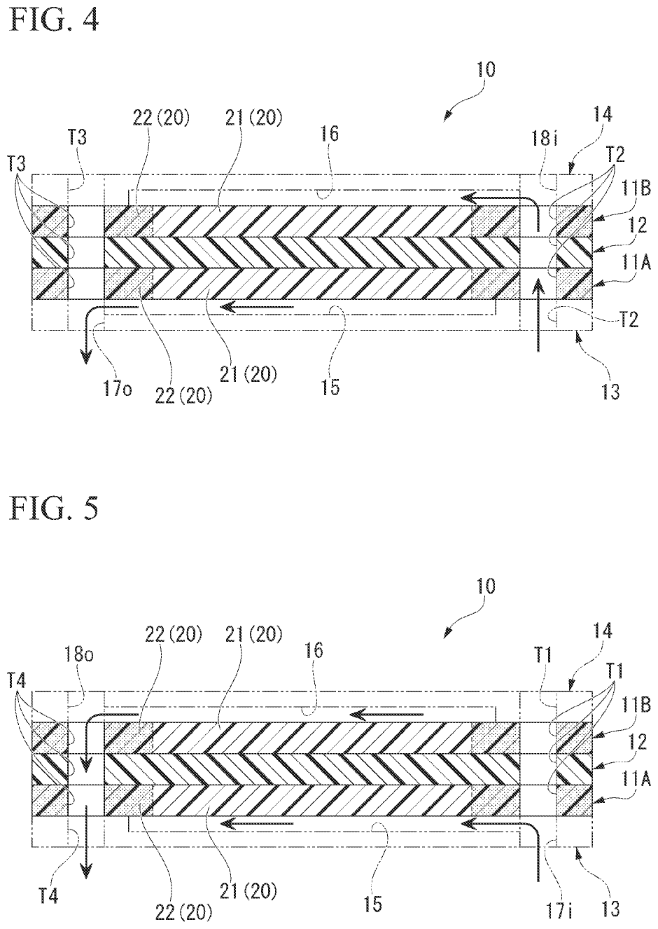

FIG. 2 is an exploded perspective view of the electrochemical cell 10 of the embodiment, and FIG. 3 is an exploded front view of a part of the electrochemical cell 10. In addition, FIG. 4 is a view showing a cross section corresponding to a cross section along line IV-IV of FIG. 2, and FIG. 5 is a view showing a cross section corresponding to a cross section along line V-V of FIG. 2.

The electrochemical cell 10 includes a pair of sheet-shaped electrode structures 11A and 11B, an electrolyte film 12 disposed between the pair of electrode structures 11A and 11B, a first separator 13 facing the one electrode structure 11A on one side in the stacking direction, and a second separator 14 facing the other electrode structure 11B on the other side in the stacking direction.

In the embodiment, the electrode structures 11A and 11B, the electrolyte film 12, the first separator 13, and the second separator 14 all have a horizontally long rectangular shape when viewed from the front. However, their shapes are not limited to this shape.

The one electrode structure 11A constitutes the anode electrode, and the other electrode structure 11B constitutes the cathode electrode. The one electrode structure 11A and the other electrode structure 11B are connected to a positive electrode and a negative electrode of the power supply (not shown), respectively. A detailed structure of the electrode structures 11A and 11B will be described below in detail.

The electrolyte film 12 is a film material such as a solid polymer film or the like configured to allow penetration of ions between the anode electrode (the one electrode structure 11A) and the cathode electrode (the other electrode structure 11B).

The first separator 13 is placed on a side of the electrode structure 11A which is the opposite side of the side where the electrolyte film 12 is present in the one electrode structure 11A. The first separator 13 forms a flow passage 15 through which an electrochemical reaction fluid (for example, the anode solution containing water) flows between the first separator 13 and the one electrode structure 11A. The flow passage 15 formed between the first separator 13 and the one electrode structure 11A is hereinafter referred to as “the anode-side flow passage 15.”

A fluid introduction port 17i configured to introduce a fluid such as an anode solution or the like into the anode-side flow passage 15 is formed on one side of the first separator 13 in a widthwise direction. A fluid discharge port 17o configured to discharge the fluid discharged from the anode-side flow passage 15 to the outside together with a product material such as oxygen or the like is formed on the other side of the first separator 13 in the widthwise direction. Both the fluid introduction port 17i and the fluid discharge port 17o pass through the first separator 13 in the thickness direction.

Similar penetration ports T1 and T3 are formed at positions to overlap the fluid introduction port 17i and the fluid discharge port 17o of the other member stacked on the first separator 13, respectively. For this reason, a fluid is introduced into each of the anode-side flow passages 15 of the plurality of stacked electrochemical cells 10 in parallel through the penetration port T1 and the fluid introduction port 17i. In addition, the fluid and the product material are discharged from each of the anode-side flow passages 15 of the plurality of stacked electrochemical cells 10 to the outside through the fluid discharge port 17o and the penetration port T3.

The second separator 14 is placed on a side of the electrode structure 11B which is the opposite side of the side where the electrolyte film 12 is present in the electrode structure 11B. The second separator 14 forms a flow passage 16 through which an electrochemical reaction fluid (for example, carbon dioxide gas) flows between the second separator 14 and the other electrode structure 11B. The flow passage 16 formed between the second separator 14 and the other electrode structure 11B is hereinafter referred to as “the cathode-side flow passage 16.”

A fluid introduction port 18i configured to introduce a fluid such as carbon dioxide gas or the like into the cathode-side flow passage 16 is formed on one side of the second separator 14 in the widthwise direction. A fluid discharge port 18o configured to discharge the fluid discharged from the cathode-side flow passage 16 to the outside together with a product material such as carbon monoxide or the like is formed on the other side of the second separator 14 in the widthwise direction. Both the fluid introduction port 18i and the fluid discharge port 18o pass through the second separator 14 in the thickness direction.

Similar penetration ports T2 and T4 are formed at positions to overlap the fluid introduction port 18i and the fluid discharge port 18o of the other member stacked on the second separator 14. For this reason, a fluid is introduced into each of the cathode-side flow passages 16 of the plurality of stacked electrochemical cells 10 in parallel through the penetration port T2 and the fluid introduction port 18i. In addition, the fluid and the product material are discharged from each of the cathode-side flow passages 16 of the plurality of stacked electrochemical cells 10 through the fluid discharge port 18o and the penetration port T4.

Next, a detailed structure of the electrode structures 11A and 11B will be described.

Each of the electrode structures 11A and 11B includes a sheet-shaped electrode base member 20 formed of a porous material such as carbon non-woven fabric or the like. The electrode base member 20 is formed in a rectangular shape having the same size as the electrolyte film 12. An electrode function part 21 having a diffusion layer and a catalyst layer (not shown), and a seal function part 22 disposed in an outer peripheral region of the electrode function part 21 are provided on the electrode base member 20. The seal function part 22 is formed by impregnating the outer peripheral region of the electrode base member 20 made of a porous material with an elastomer such as rubber. The elastomer of the seal function part 22 is impregnated into the electrode base member 20 to cover the outer peripheral portion of the electrode function part 21 and the outer peripheral portions of the penetration ports T1, T2, T3 and T4.

Further, the electrode structures 11A and 11B and the electrolyte film 12 of the embodiment become a film electrode complex in which the electrode structures 11A and 11B are directly bonded to the electrolyte film 12. However, the electrode structures 11A and 11B may be used as a separate structure from the electrolyte film 12.

The seal function part 22 formed by impregnating the outer peripheral region of the electrode base member 20 with the elastomer is able to abut the first separator 13 or the second separator 14 adjacent thereto on the end surface in the stacking direction. The seal function part 22 of each of the electrode structures 11A and 11B is pressed against the outer peripheral region of the first separator 13 or the second separator 14 adjacent thereto in the stacking direction upon assembly of the electrolytic apparatus 1, which will be described below. Accordingly, the outer peripheral region of the anode-side flow passage 15 or the outer peripheral region of the cathode-side flow passage 16 is sealed by the seal function part 22, and the outer peripheral region of each of the penetration ports T1, T2, T3 and T4 is also sealed by the seal function part 22.

Next, assembly of the electrolytic apparatus 1 will be described.

Components (the film electrode complex constituted by the electrolyte film 12 and the electrode structures 11A and 11B, the first separator 13, and the second separator 14) of the plurality of electrochemical cells 10 are prepared in advance. In this state, the electrochemical cell 10 obtained by stacking the first separator 13, the film electrode complex, and the second separator 14 in sequence is placed on the electrochemical cell 10 obtained by stacking the components similarly. In this state, the pair of end plates 2 (see FIG. 1) are disposed on end portions in the stacking direction, and fastened by the fastening member 3 in a direction in which the pair of end plates 2 approach each other.

As a result, in each of the electrochemical cells 10 of the electrolytic apparatus 1, the seal function part 22 of each of the electrode structures 11A and 11B of the film electrode complex is pressed against the separator adjacent thereto. As a result, leakage of the fluid from the flow passage of each of the electrochemical cells 10 is prevented.

As described above, in the electrode structures 11A and 11B of the embodiment, the electrode function part 21 and the seal function part 22 are provided on the electrode base member 20 formed of a porous material. Then, the seal function part 22 is disposed in a region that surrounds the outer peripheral region of the electrode function part 21 and configured by impregnating the porous material of the electrode base member 20 with the elastomer. In the electrode structures 11A and 11B of the embodiment, since the elastomer of the seal function part 22 is supported by the porous material of the electrode base member 20, the seal function part 22 is not easily crushed even if it is pressed against the other member in the stacking direction, and reliably comes into contact with the mated member. For this reason, the electrode structures 11A and 11B do not require the seal function part 22 to be greatly bulged in the stacking direction in advance.

Accordingly, when the electrode structures 11A and 11B, the electrochemical cell 10, and the electrolytic apparatus 1 of the embodiment are employed, the electrochemical cell 10 can be thinned in the stacking direction, and the plurality of electrochemical cells 10 can be easily fastened and fixed upon assembly of the electrolytic apparatus 1 (electrochemical apparatus).

In addition, in the electrode structures 11A and 11B of the embodiment, the seal function part impregnated with the elastomer abuts the first separator 13 or the second separator 14. For this reason, in the electrochemical cell 10 employing the electrode structures 11A and 11B of the embodiment, leakage of the fluid to the outside from the anode-side flow passage 15 or the cathode-side flow passage 16 between the electrode function part 21 and each of the separators 13 and 14 can be reliably prevented by the seal function part 22 of the electrode structures 11A and 11B.

Further, in the electrode structures 11A and 11B of the embodiment, peripheral regions of the penetration ports T1, T2, T3 and T4 of the electrode structures 11A and 11B are also impregnated with the elastomer. For this reason, the leakage of the fluid from the peripheral region of the penetration ports T1, T2, T3 and T4 can also be reliably prevented. Accordingly, when the configuration is employed, so-called cross leak in which the fluid flowing through the one flow passage is mixed with the fluid flowing through the other flow passage can also be reliably prevented.

In addition, the electrode structures 11A and 11B of the embodiment are formed to have substantially the same size as the outer edge portions of the first separator 13 and the second separator 14. For this reason, upon assembly of the electrolytic apparatus 1, by aligning the outer edge portions of the electrode structures 11A and 11B with the outer edge portions of the adjacent separators 13 and 14, the electrode structures 11A and 11B can be easily positioned at the proper position.

Accordingly, when the configuration is employed, an assembly work of the electrolytic apparatus 1 is further facilitated.

### Second Embodiment

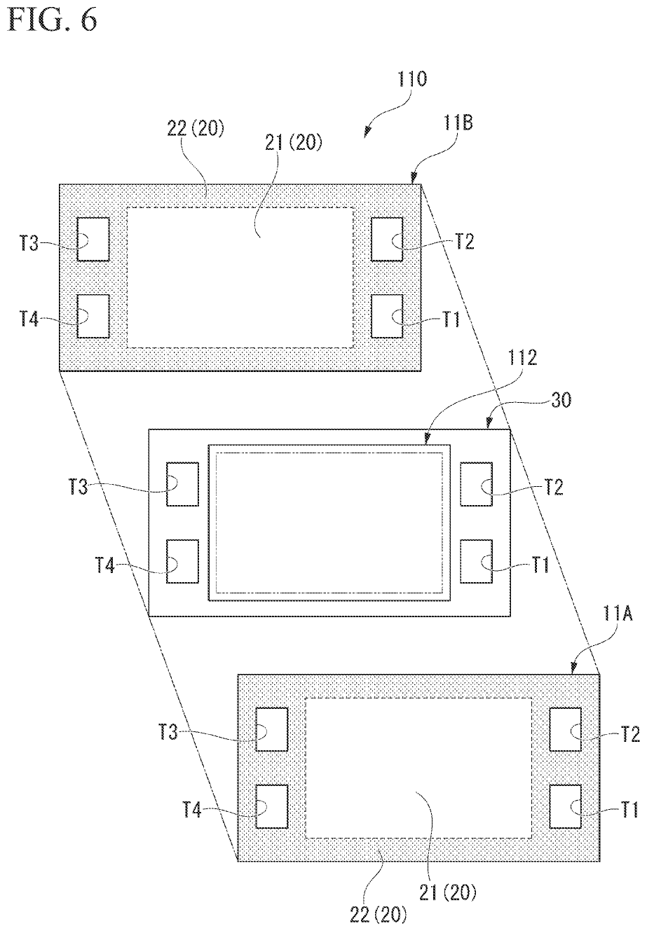

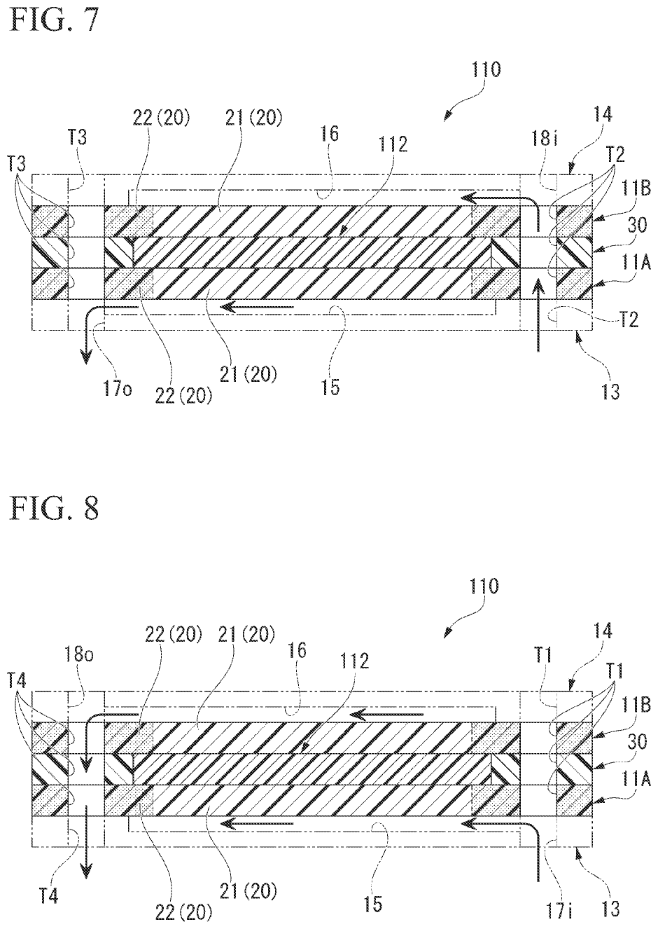

FIG. 6 is a partially exploded front view of an electrochemical cell 110 of an embodiment, and FIG. 7 is a cross-sectional view of the electrochemical cell 110 of the embodiment corresponding to FIG. 4 of the first embodiment. In addition, FIG. 8 is a cross-sectional view of the electrochemical cell 110 of the embodiment corresponding to FIG. 5 of the first embodiment.

While the electrochemical cell 110 of the embodiment has substantially the same basic configuration as that of the first embodiment, a size of an electrolyte film 112 is formed to be slightly smaller than the electrode structures 11A and 11B. Then, an outer edge portion of the electrolyte film 112 is held by a rectangular holding frame 30 having the same size as the electrode structures 11A and 11B. The holding frame 30 is formed of, for example, a non-conductive material. An outer peripheral edge portion of each of the electrode structures 11A and 11B abuts an end surface of the seal function part 22 in the stacking direction of the holding frame 30. Accordingly, the seal function part 22 of the one electrode structure 11A comes into close contact with the first separator 13 and one surface of the holding frame 30, and the seal function part 22 of the other electrode structure 11B comes into close contact with the second separator 14 and the other surface of the holding frame 30.

In the electrochemical cell 110 of the embodiment, although the seal function part 22 of the outer peripheral edge portion of the electrode structures 11A and 11B is in close contact with the holding frame 30 outside the electrolyte film 112, the same effect as that of the first embodiment described above can be obtained.

Even when the electrochemical cell 110 of the embodiment is employed, the electrochemical cell 110 can be thinned in the stacking direction, and the plurality of electrochemical cells 110 can be easily fastened and fixed upon assembly of the electrolytic apparatus 1 (electrochemical apparatus).

### Third Embodiment

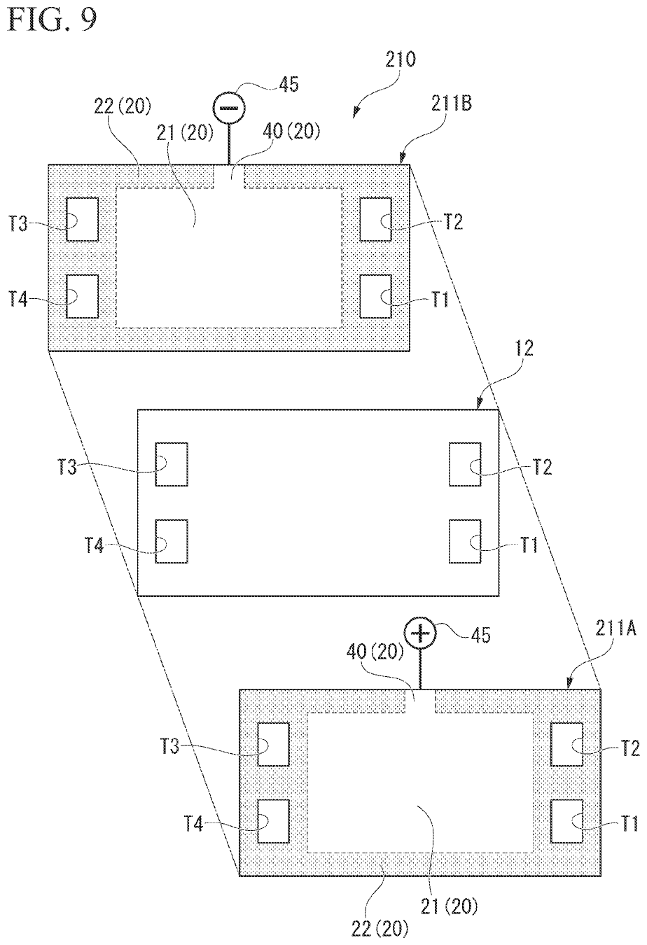

FIG. 9 is a partially exploded front view of an electrochemical cell of an embodiment.

An electrochemical cell 210 of the embodiment has substantially the same basic configuration as that of the first embodiment. However, in each of electrode structures 211A and 211B, an electric conduction part 40 electrically connected to a power supply 45 is provided on a part of the outer peripheral edge portion of the electrode base member 20. The electric conduction part 40 is electrically conducted to the electrode function part 21 of a central region, and the porous material of the electrode base member 20 is not impregnated with the elastomer.

Since the electrochemical cell 210 of the embodiment has the same basic configuration as that of the first embodiment, the same effect as the first embodiment can be obtained.

In the electrochemical cell 210 of the embodiment, in addition to this, since the electrode function part 21 is electrically conducted to a part of the outer edge portion of the electrode base member 20 and the electric conduction part 40 that is not impregnated with the elastomer is provided, the electrode function part 21 can be easily connected to the power supply 45 through the electric conduction part 40 of the electrode structures 211A and 211B without adding a complicated electric conduction structure.

Further, the present invention is not limited to the above-mentioned embodiments, and various design changes may be made without departing from the scope of the present invention. For example, in the embodiment, while the fluid introduction ports 17i and 18i, the fluid discharge ports 17o and 18o, the penetration ports T1, T2, T3 and T4, or the like, are provided on both sides of each of the electrochemical cells 10 in the widthwise direction to form an introduction route and a discharge route for a fluid, the introduction route or the discharge route for a fluid is not limited thereto. These ports may have another shape as long as the fluid can be appropriately introduced into the anode-side flow passage 15 and the cathode-side flow passage 16 and the fluid after reaction can be appropriately discharged from each of the flow passages.

In addition, in the embodiment, while only the outer peripheral region of the electrode function part 21 in the electrode base member 20 is impregnated with the elastomer, the impregnated region (the seal function part 22) of the elastomer may be at least the outer peripheral portion of the electrode function part 21. For example, a portion of the impregnated region (the seal function part 22) of the elastomer may extend in the direction of the electrode function part 21.

In addition, in the embodiment, while the electrolytic apparatus 1 for carbon dioxide electrolysis that is an aspect of the electrochemical apparatus has been described, the electrochemical apparatus is not limited thereto. The electrochemical apparatus may be an electrolytic apparatus configured to electrolyze a material other than the carbon dioxide.

Further, the electrochemical apparatus may be a fuel cell configured to supply a fuel gas and an oxidant gas to an electrode structure to perform power generation.

While preferred embodiments of the invention have been described and illustrated above, it should be understood that these are exemplary of the invention and are not to be considered as limiting. Additions, omissions, substitutions, and other modifications can be made without departing from the scope of the present invention. Accordingly, the invention is not to be considered as being limited by the foregoing description, and is only limited by the scope of the appended claims.

What is claimed is:

1. An electrode structure for an electrochemical cell comprising a sheet-shaped electrode base member formed of a porous material,
wherein the electrode base member is provided with:
an electrode function part having a diffusion layer and a catalyst layer; and
a seal function part disposed on at least an outer peripheral region of the electrode function part and formed by impregnating the electrode base member with an elastomer.

2. The electrode structure for an electrochemical cell according to claim 1, wherein the seal function part is placed on the electrode base member, and is able to abut a separator that forms a flow passage for an electrochemical reaction fluid between the separator and the electrode function part, or a holding frame of the separator.

3. The electrode structure for an electrochemical cell according to claim 1, wherein an electric conduction part, which is electrically conducted to the electrode function part and which is not impregnated with the elastomer, is disposed on at least a part of an outer edge portion of the electrode base member.

4. An electrochemical cell comprising:
a pair of sheet-shaped electrode structures;
an electrolyte film disposed between the pair of electrode structures and configured to allow penetration of ions; and
a pair of separators respectively disposed on sides of each of the electrode structures which are opposite sides of sides where the electrolyte film is present in each of the electrode structures and configured to form a flow passage for an electrochemical reaction fluid between the separators and the electrode structures,
wherein the pair of electrode structures include sheet-shaped electrode base members formed of a porous material,
the electrode base member is provided with:
an electrode function part having a diffusion layer and a catalyst layer; and
a seal function part disposed on at least an outer peripheral region of the electrode function part and formed by impregnating the electrode base member with an elastomer, and
the seal function part of each of the electrode structures abuts the separator, or a holding frame of the separator.

5. An electrochemical apparatus comprising:
a plurality of the electrochemical cells according to claim 4;
a pair of end plates configured to sandwich the plurality of electrochemical cells from both sides in a stacking direction; and
a fastening member configured to fasten the pair of end plates and fix the plurality of electrochemical cells to each other in an approaching direction.
